(19) United States
(12) Patent Application Publication
(10) Pub. No.: US 2026/0016125 A1
(43) Pub. Date: Jan. 15, 2026

(54) HYDROGEN PRESSURE VESSEL

(71) Applicant: TENARIS CONNECTIONS B.V., Amsterdam (NL)

(72) Inventors: Paolo Bortot, Dalmine (IT); Michele Sileo, Dalmine (IT); Matteo Ortolani, Dalmine (IT); Erick Arturo Escorza Marquez, Dalmine (IT)

(73) Assignee: TENARIS CONNECTIONS B.V., Amsterdam (NL)

(21) Appl. No.: 19/140,611

(22) PCT Filed: Dec. 20, 2023
(86) PCT No.: PCT/EP2023/086936

§ 371 Date: Jun. 18, 2025

(30) Foreign Application Priority Data
Dec. 21, 2022 (NL) 2033784

(51) Int. Cl. F17C 13/00

(52) U.S. Cl. CPC F17C 13/002; F17C 2201/0109; F17C 2201/052; F17C 2203/0629; F17C 2203/0643; F17C 2205/0138; F17C 2209/22; F17C 2221/012; F17C 2223/0123; F17C 2223/036; F17C 2250/0486

(57) ABSTRACT

Hydrogen pressure vessel, comprising a shell with an internal volume; wherein:
the pressure vessel is arranged for storing compressed hydrogen at a pressure greater than 200 bar;
the shell is made of a steel having a yield strength (S_{y}) of at least 355 MPa; and
said shell is formed by a multitude of longitudinally extending segments, wherein each longitudinally extending segment has a circumferential wall, with a wall thickness (WT), defining an internal diameter (ID₁), the multitude of longitudinally extending segments together forming the internal volume of the shell.

### TECHNICAL FIELD

The present invention relates to a hydrogen pressure vessel, a hydrogen pressure vessel assembly, and a method of manufacturing a hydrogen pressure vessel.

In order to make hydrogen a viable alternative to traditional fuels, such as methane, there is a need to efficiently store hydrogen. To store hydrogen efficiently, it is possible to contain hydrogen at very low temperatures such that the hydrogen takes a liquid form, to chemically bind hydrogen to other materials, or to maintain hydrogen at high pressures. The present invention relates to storing hydrogen in a hydrogen pressure vessel at a high pressure. With high pressure is meant; a pressure of greater than 200 bar.

Within the technical field of hydrogen pressure vessels, a distinction can be made concerning the type of vessel that is used to store compressed hydrogen at a high pressure. In general, hydrogen pressure vessels have a cylindrical hollow shell that is closed off at each axial end thereof by a domed head or a flange. Vessel types include carbon steel and low alloy steel pressure vessels; metal pressure vessels wrapped with fiber resin composite material; and polymer pressure vessels. At present, the latter two types are relatively expensive to manufacture, whereas the carbon steel and low alloy steel vessels are generally cheaper to produce and commonly used at commercial storage facilities. The pressure vessel of the present invention is made of carbon steel and/or low alloy steel.

A large steel hydrogen storage cylinder for storing hydrogen is known. This storage cylinder is, however, of limited length and limited to holding hydrogen at pressures up to 100 bar due to structural constraints, in particular due to the presence of a weld extending along the entire length of the cylinder. As such, the storage cylinder has only a limited storage capacity.

If a greater storage capacity at the storage location is required, one could increase the size of the storage cylinder. However, doing so introduces practical problems. In particular, the pressure vessel may become too big and too heavy to handle, to transport, and difficult to manufacture.

A hydrogen storage assembly, comprising a multitude of cylinders is known. Each of the cylinders is supported at the ends thereof by an end support, wherein the cylinders are arranged in parallel with respect to each other. If more hydrogen at the storage location is required, more cylinders or more assemblies, can be added at the storage location.

A problem of such a hydrogen storage assembly is, that this type storage generally has a lot of operation requirements. In particular, in many countries present safety regulations relating to hydrogen storage systems consider that each individual vessel is an independent system, wherein each independent system should be monitored for safety reasons. This problem is amplified as the storage capacity of the assembly increases. Also, storing a large amount of hydrogen in this way requires many valves, and piping manifolds, which makes storing larger quantities relatively complex and susceptible to leakage.

Moreover, hydrogen transport systems are known. These systems are generally designed to transport hydrogen from one place to another at a pressure lower than 100 bar via pipelines arranged with many bends, and branches. As such, the system comprises pipelines extending in multiple directions.

A problem of such pipeline systems is, that these systems typically have relatively complex structure. Generally, there is also no need to storing large amounts of hydrogen in the pipeline, as the pipeline can be used for providing hydrogen via the pipeline from one location to another. In these systems, the flow rate is of particular relevance.

It is an object of the present invention to provide an improved, or at least alternative, hydrogen pressure vessel for storing hydrogen. In particular, it is an object of the present invention to provide a hydrogen pressure vessel that is suitable for efficiently storing a large amount of hydrogen, wherein costs for construction and operation are kept relatively low.

The above object is achieved in a first aspect of the present invention with a hydrogen pressure vessel, comprising a shell with an internal volume; wherein:
the pressure vessel is arranged for storing compressed hydrogen at a pressure greater than 200 bar;
the shell is made of a steel having a yield strength (S_{y}) of at least 355 MPa; and
said shell is formed by a multitude of longitudinally extending segments, wherein each longitudinally extending segment has a circumferential wall, with a wall thickness (WT), defining an internal diameter (ID₁), the multitude of longitudinally extending segments together forming the internal volume of the shell.

By providing a hydrogen pressure vessel suitable for storing hydrogen at a pressure greater than 200 bar, wherein the shell is formed by a multitude of longitudinally extending segments with a circumferential wall, and wherein the multitude of longitudinally extending segments together form the internal volume of the shell, it is possible to selectively adjust the storage capacity of the hydrogen pressure vessel depending on the storage requirements at the storage location. At the same time, as the shell of the pressure vessel is made of two or more segments, it is possible to manufacture a relatively large hydrogen pressure vessel, wherein few heavy or difficult to handle parts need to be manufactured and/or handled. As such, a flexible solution is provided, wherein conventional machines and tools may be used for manufacturing the hydrogen pressure vessel. Accordingly, with the present invention it is possible to provide a hydrogen pressure vessel capable of storing a large amount of hydrogen, wherein costs for construction and operation are kept relatively low.

Further to the above advantages, the hydrogen pressure vessel of the present invention forms a single system, wherein generally little monitoring, and/or certification of components, is required to comply with safety regulations.

It is understood that, when hydrogen is kept at a greater pressure, the storage capacity of the pressure vessel may be improved. However, making the pressure vessel suitable to contain hydrogen at greater pressures comes with important disadvantages concerning the costs of manufacturing and handling. In particular, it is possible to select a steel with a higher yield strength. However, steels with a higher yield strength typically have a lower resistance to the effects of hydrogen on the material properties of the material than steels with a lower yield strength. Also, the toughness of the material may go down as the yield strength increases, wherein the material may become brittle. It is also possible to adjust the wall thickness of the vessel. This, however, comes with the disadvantage of increasing the mass and therewith the weight of the vessel. Adding too much weight to the vessel parts may put constraints on manufacturing, as conventional machines and tools may no longer be used. To reduce the weight, it is possible to reduce the longitudinal length of the to be handled parts, but this would make it difficult to obtain longer hydrogen pressure vessels. Further, it is possible to add structural reinforcement to the steel hydrogen pressure vessel. However, this option also tends to increase the cost of manufacturing and handling, in particular, because adding the reinforcement would be an additional step in the manufacturing process, and/or may require additional steps during assembly of the hydrogen pressure vessel.

In designing the pressure vessel in accordance with the present invention, the inventors learned that that if the segments are made of a steel having a yield strength (S_{y}) of at least 355 MPa, the wall thickness of the vessel parts can be kept relatively small without making big concessions to the material's suitability for storing hydrogen. In particular, the material must not deteriorate even after multiple cycles of loading and unloading of the pressure vessel.

Examples of steels having a yield strength at least 355 MPa are steel grades API 5L X65, EN 10216-3 P355 or P460, and API 5L X80QO PSL2.

Within the context of the present disclosure, the yield strength may be a minimum specified yield strength. As is convention in the technical field, the minimum specified yield strength relates to the minimum yield strength prescribed by the specification under which the material is purchased from a manufacturer. Standard test methods, such as those provided by the American Society for Testing and Materials, are available for determining the yield strength of metallic materials.

The shell may comprise a first axial shell end, and a second axial shell end located opposite to the first axial shell end. The hydrogen pressure vessel may further comprise a first closure, and a second closure, wherein the first closure closes the first axial end of the shell, and the second closure closes the second axial end of the shell. The shell is located in between the first and second closures.

The longitudinally extending segments may be connected to each other by means of welds. Similarly, the first closure may be connected to the first axial shell end by means of a weld, and the second closure may be connected to the second axial shell end by means of a weld. In particular, the welds may extend in a tangential direction along the circumferential wall of the longitudinally extending segments.

The welds may be made of a carbon steel being similar or the same as, or having higher yield strength than, the carbon steel of the shell.

Alternatively, the longitudinally extending segments may be connected to each other by means of a threaded connection. In such case, each threaded connection comprises a male tubular member, and a female tubular member, the male tubular member having a male threaded zone provided at an external surface of the male tubular member, and a male sealing surface adjacent said male threaded zone, the female tubular member having a female threaded zone provided at an internal surface of the female tubular member, and a female sealing surface adjacent said female threaded zone, wherein the male threaded zone and the female threaded zone are configured to engage with each other upon rotational make-up, wherein, at a final make-up position of the threaded connection, the male sealing surface contacts the female sealing surface to form a metal to metal seal. In particular, each segment may comprise at a first axial segment end a first male tubular member or a first female tubular member, and at a second axial segment end opposite to said first axial segment end a second male tubular member or a second female tubular member.

Similarly, the first closure may be connected to a first axial segment end by means of a first threaded connection, and the second closure may be connected to a second axial segment end by means of a second threaded connection. Said first and second threaded connections may be identical to the above-described threaded connection. In particular, the longitudinally extending segments may comprise the female tubular member, wherein the first closure and the second closure each comprise the male tubular member.

The hydrogen pressure vessel is hollow. In particular, the hollow hydrogen pressure vessel has an interior volume, wherein the interior volume of the pressure vessel is defined by the circumferential wall of the longitudinally extending segments, and by the first and second closures.

The shell has an internal volume defined by the circumferential wall of the segments. In particular, the longitudinally extending segments are aligned around the same longitudinal axis, wherein the segments are connected to each other. As such, the segments form a single internal volume of the shell.

Within the context of the present disclosure, with the terms “circumferential” or “circumference” may be meant: the perimeter of a circle. As such, the circumferential wall of the segments may be circular. In particular, the circumferential wall of the segments may have a circular cross section.

In particular, the circumferential wall of the segments define an internal circumferential wall surface, and an external circumferential wall surface. The internal circumferential wall surface may be cylindrical, or have cylindrical portions.

In particular, the first closure may comprise a first closure wall, wherein the first closure wall defines a first closure wall internal surface, and a first closure wall external surface. The second closure may comprise a second closure wall, wherein the second closure wall defines a second closure wall internal surface, and a second closure wall external surface.

The first closure, and the second closure, may be made of a steel having a yield strength of at least 355 MPa.

Within the context of the present disclosure, the terms: “internal” and “external” may be interpreted in relation to the interior of the hydrogen pressure vessel. For instance, an internal surface may be facing towards the interior of the pressure vessel, and an external surface may be facing away from the interior of the pressure vessel.

The hydrogen pressure vessel can have a longitudinal axis. The vessel may have a single longitudinal axis. In particular, the hydrogen pressure vessel may extend along the longitudinal axis, wherein the hydrogen pressure vessel starts in a first direction, and ends in the first direction. More in particular, each of the multitude of longitudinally extending segments has a longitudinal axis, which longitudinal axis is the same as the longitudinal axis of the vessel. Even more in particular, the longitudinally extending segments are arranged concentrically with respect to each other. The longitudinally extending segments may extend in axial direction along the longitudinal axis.

The wall thickness of the segments may be measured in radial direction with respect to the longitudinal axis.

The internal diameter of the segments may be measured in radial direction with respect to the longitudinal axis. The internal diameter of the segments may be a largest internal diameter.

The hydrogen pressure vessel of the present invention may be suitable for storing compressed hydrogen as a gas, in particular, without having the hydrogen being physically or chemically bonded to other materials.

In particular, the hydrogen pressure vessel may be made of a single carbon steel or single low alloy steel. More in particular, the first closure, the second closure, and the circumferential wall of the segments may each be made of the same carbon steel or low alloy steel material. Even more in particular, the first closure wall, the second closure wall, and the circumferential wall of the segments may be formed of a single material layer, or in other words; free from more than one layer.

The hydrogen pressure vessel may comprise one or more valves. In particular, the first or second closure comprises a valve. Alternatively, the first closure and the second closure comprise a valve.

Within the context of the present disclosure, with a “valve” may be meant: a mechanical device for starting or stopping the flow of a hydrogen fluid into or out of the hydrogen pressure vessel. The valve may be connected to valve steering means.

Embodiments in accordance with the first, a second, and a third aspect of the present invention are described in the following.

In an embodiment in accordance with the first aspect of the present invention, the hydrogen pressure vessel further comprises a first closure at a first axial shell end, and a second closure at a second axial shell end opposite the first axial shell end.

In an embodiment in accordance with the first aspect of the present invention, the longitudinally extending segments comply with:

$$0.045 \leq \frac{{WT}_{min}}{{ID}_{1}} \leq 0.299 . \qquad ( 1 )$$

In an embodiment in accordance with the first aspect of the present invention, the longitudinally extending segments comply with:

$$0.045 \leq \frac{{WT}_{min}}{{ID}_{1}} \leq 0.088 , \qquad ( 2 )$$

in particular,

$$0.049 \leq \frac{{WT}_{min}}{{ID}_{1}} \leq 0.088 . \qquad ( 3 )$$

WTₘᵢₙ is the minimum required wall thickness of the segments, and ID₁ is the internal diameter of the segments.

In developing suitable vessel segments, the inventors learned that steels with a higher yield strength typically have a lower resistance to the effects of hydrogen on the material properties of the material than steels with a lower yield strength. As such, in order to provide a vessel suitable for maintaining hydrogen above 200 bar, the inventors opted for using a carbon steel with an acceptable yield strength, wherein a suitable WT/ID ratio is selected, rather than merely selecting a carbon steel with a higher yield strength.

Advantageously, as will be explained in more detail below, a pressure vessel complying with expression (1), (2), and/or (3) above, allows to efficiently store a large amount of hydrogen, in particular, with regards to the material required for manufacturing the pressure vessel.

In an embodiment in accordance with the first aspect of the present invention, the steel of the shell has a yield strength greater than 355 MPa.

In an embodiment in accordance with the first aspect of the present invention, the steel of the shell complies with:

$$460 MPa \leq {S}_{y} \leq 690 MPa , \qquad ( 4 )$$

in particular,

$${S}_{y} \leq 690 MPa , \qquad ( 5 )$$

wherein S_{y} is the yield strength of the steel.

In an embodiment in accordance with the first aspect of the present invention, the steel of the first closure, and/or the second closure, complies with:

$$460 MPa \leq {S}_{y} \leq 690 MPa , \qquad ( 4 )$$

in particular,

$${S}_{y} \leq 690 MPa , \qquad ( 5 )$$

wherein S_{y} is the yield strength of the steel.

In an embodiment in accordance with the first aspect of the present invention, the longitudinally extending segments comply with:

$$203 mm \leq {ID}_{1} \leq 610 mm , \qquad ( 6 )$$

in particular,

$$254 mm \leq {ID}_{1} \leq 610 mm , \qquad ( 7 )$$

more in particular,

$$406 mm \leq {ID}_{1} \leq 610 mm . \qquad ( 8 )$$

In an embodiment in accordance with the first aspect of the present invention, the longitudinally extending segments comply with:

$$11.4 mm \leq {WT}_{min} \leq 60.8 mm , \qquad ( 9 )$$

$$in particular ,$$

$$19.9 mm \leq {WT}_{min} \leq 45.3 mm . \qquad ( 10 )$$

In an embodiment in accordance with the first aspect of the present invention, the pressure vessel is arranged for storing compressed hydrogen at a pressure of 200 bar to 1000 bar, in particular 200 bar to 500 bar, more in particular 200 bar to 350 bar, even more in particular 300 bar.

In an embodiment in accordance with the first aspect of the present invention, the first closure has a first closure wall with a first closure wall thickness, wherein the first closure wall thickness, is equal to the wall thickness (WT) of the circumferential wall of the segments. In particular, the second closure may have second closure wall with a second closure wall thickness, wherein the second closure wall thickness is equal to the wall thickness (WT) of the circumferential wall of the segments.

In an embodiment in accordance with the first aspect of the present invention, the second closure comprises a flange. Said flange comprising a first (circular) flange part having a circumferential edge that defines an opening, and a second (circular) flange part for closing said opening. Said first flange part may comprise threaded bores in said edge along the circumference thereof, and said second flange part may comprise through holes at its circumference for receiving bolts, wherein the first flange part is connected to the second flange part by means of bolts extending through the through holes, and at least engaging the threaded bores.

In an embodiment in accordance with the first aspect of the present invention, the first closure comprises a domed shape, and/or the second closure comprises a domed shape.

In an embodiment in accordance with the first aspect of the present invention, the vessel has a longitudinal vessel length of at least 100 meters, in particular at least 200 meters.

In an embodiment in accordance with the first aspect of the present invention, the longitudinal vessel length is 100 meters to 1200 meters, in particular 200 meters to 300 meters.

In an embodiment in accordance with the first aspect of the present invention, the segments have a longitudinal segment length of 30 meters to 100 meters, in particular 77 meters.

In an embodiment in accordance with the first aspect of the present invention, each segment is seamless. Within the present disclosure, with the term “seamless” may be meant: free from a weld extending substantially in longitudinal direction. In particular, the circumferential wall of the segments may be uninterrupted in circumferential direction.

In an embodiment in accordance with the first aspect of the present invention, the segments comprise a first axial segment end, and a second axial segment end.

In an embodiment in accordance with the first aspect of the present invention, the segments are connected to each other by means of a weld extending along the circumferential wall, in particular, the weld is provided at the first axial segment end, and at the second axial segment end, of the segments.

The inventors considered that, during loading and unloading for the pressure vessel, an internal pressure change may cause stresses in the circumferential wall which stresses mainly act in tangential direction. Welds may be in particular susceptible to damage due to these stresses. By providing a circumferential wall without welds extending in longitudinal direction, the hydrogen pressure vessel may be more robust.

Moreover, contact with hydrogen may degrade material properties of welds. The total weld length of a hydrogen pressure vessel in accordance with the present invention may be smaller than in the case of a longitudinal weld.

As will be appreciated, employing a vessel that is free from longitudinal welds enables more design freedom with respect to the above-described wall thickness over internal diameter ratio. As the welds pose less of a liability, one can be less conservative with selecting a minimum wall thickness. Accordingly, the wall thickness over internal diameter ratio may be further reduced.

In an embodiment in accordance with the first aspect of the present invention, the segments are free from an internal and/or external support structure, in particular, for supporting the circumferential wall against a pressure build-up in the interior volume of the vessel.

In an embodiment in accordance with the first aspect of the present invention, the first axial segment end has a first external diameter, the second axial segment end has a second external diameter, and the segments have a main segment body, that is located between the first axial segment end and the second axial segment end, said main segment body having a third external diameter.

In an embodiment in accordance with the first aspect of the present invention, the shell comprises segments of which the first external diameter is smaller than the second external diameter.

In an embodiment in accordance with the first aspect of the present invention, the shell comprises segments of which the third external diameter is greater than the first external diameter and than the second external diameter, in particular, wherein the first external diameter is equal to the second external diameter. More in particular, each segment comprises a third external diameter that is greater than the first external diameter and than the second external diameter, even more in particular, wherein the first external diameter is equal to the second external diameter.

The above two embodiments may improve manufacturing, because the connection between segments, and between segments and closures, may be relatively small, in particular, because a weld connecting the segments together may be relatively short.

In an embodiment in accordance with the first aspect of the present invention, the circumferential wall of each segment is an internal circumferential wall, and each segment further comprises an external circumferential wall located at a distance from the internal circumferential wall. The first closure may be connected to the internal circumferential wall, and to the external circumferential wall of a segment, and the second closure may be connected to the internal circumferential wall, and to the external circumferential wall of another segment. In particular, the first closure wall may be a first internal closure wall, and the first closure further comprises a first external closure wall, wherein the first external closure wall is connected to the external circumferential wall. More in particular, the second closure wall may be a second internal closure wall, and the second closure further comprises a second external closure wall, wherein the first external closure wall and the second external closure wall are connected to the external circumferential wall.

In an embodiment in accordance with the first aspect of the present invention, the hydrogen pressure vessel further comprises hydrogen detection means for detecting hydrogen between the internal and external circumferential wall. An advantage of this embodiment is, when a leak is detected, servicing may be directed at a single hydrogen pressure vessel. As such, other hydrogen pressure vessels in the assembly may continue to operate.

In an embodiment in accordance with the first aspect of the present invention, the circumferential wall of each segment, the first closure, and the second closure, is provided with a hydrogen inhibiting coating. In particular, the internal circumferential wall surface of the circumferential wall, the first closure wall internal surface of the first closure, and the second closure wall internal surface, is provided with the hydrogen inhibiting coating.

In an embodiment in accordance with the first aspect of the present invention, the shell, the first closure, and the second closure are made of a ferritic stainless steel.

In a second aspect of the present invention there is provided a hydrogen pressure vessel assembly, comprising a plurality of hydrogen pressure vessels in accordance with the first aspect of the present invention.

In an embodiment in accordance with the second aspect of the present invention, each pressure vessel comprises a valve, wherein the assembly further comprises one or more compressors connected to the valves of the hydrogen pressure vessels.

In a third aspect of the present invention there is provided a method of manufacturing a hydrogen pressure vessel, comprising the steps of:
providing a multitude of longitudinally extending segments, a first closure, and a second closure, the segments being made of a steel having a yield strength (S_{y}) of at least 355 MPa; wherein each longitudinally extending segment has a circumferential wall, with a wall thickness (WT), defining an internal diameter (ID₁); and
connecting the multitude of longitudinally extending segments, the first closure, and the second closure to form a hydrogen pressure vessel with a shell having an internal volume. In particular, the step of connecting comprises welding the longitudinally extending segments, the first closure, and the second closure, together.

In an embodiment in accordance with the third aspect of the present invention, the method of manufacturing further comprises the step of:
positioning, in particular with a conventional hoisting means (such as a crane):
   the multitude of longitudinally extending segments, wherein the longitudinal axis of each segment is aligned, and wherein the first axial segment end of one segment is adjacent to the second axial segment end of another segment; and
   the first closure adjacent to the first axial segment end of one of the segments, and the second closure adjacent to the second axial segment end of another one of the segments. In particular, the multitude of longitudinally extending segments, the first closure, and the second closure are positioned in a frame before the step of connecting.

It will be clear to the skilled person that the second, and third, aspect of the present disclosure may include features relating to the first aspect of any combination of the above-described embodiments of the first aspect of the present invention.

Advantages of the present invention with respect to the first aspect may also be applicable to the second and third aspect of the present invention.

In optimizing the hydrogen pressure vessel, the inventors developed a mathematical model to approach the storage capacity of a hydrogen pressure vessel. Based on said model, the following formulas may be used to approach the storage capacity of a hydrogen pressure vessel:

$$S = \frac{{S}_{W} * {C}_{S}}{{W}_{L}} , \qquad ( 11 )$$

$${S}_{W} = {S}_{y} * {WT}_{min} , and \qquad ( 12 )$$

$${W}_{L} = {WT}_{min} ( {C}_{S} + {WT}_{min} ) , \qquad ( 13 )$$

wherein S is the specific storage capacity of the hydrogen pressure vessel, Sw is the vessel strength, Cs is the storage capacity per unit of axial length, WL is the size geometric factor for linear weight, Sy is the (minimum) yield strength of the steel, and WTmin is the minimum required wall thickness.

Based on this mathematical model, it is possible to score a developed hydrogen pressure vessel with respect to other hydrogen pressure vessels, wherein the weight of the vessel is taken into account. In particular, the specific storage capacity tells how much hydrogen may be stored per unit of weight, in particular per ton of steel. The higher the specific storage capacity, the more efficient the hydrogen pressure vessel.

Table 1 below provides an overview of various examples of hydrogen pressure vessel assemblies.

TABLE 1

| | | | [symbol] | [symbol] | | | | | [symbol] | | Required |
|---|---|---|---|---|---|---|---|---|---|---|---|
| Examp [symbol] | [symbol] | [symbol] | ID1 | Sy | [symbol] | | | | WTmin | | volume |
| # | kg | bar | mm | MPa | Y/N | [symbol] | [symbol] | [symbol] | mm | WT/ID | m3 |
| 1 | 1000 | 200 | 254 | 460 | No | 1 | ASME | Div. 1 | 17.2 | 0.068 | 60 |
| 2 | | | | | | | BPVC Sec. | Div. 2 Cl. 1 | 14.4 | 0.057 | |
| 3 | | | | | | | VIII | Div. 2 Cl. 2 | 11.4 | 0.045 | |
| 4 | | | | | | | EN 13445-3 | | 11.4 | 0.045 | |
| 5 | | 300 | 406.4 | 690 | No | 1 | ASME | Div. 1 | 30.2 | 0.074 | 40 |
| 6 | | | | | | | BPVC Sec. | Div. 2 Cl. 1 | 25.2 | 0.062 | |
| 7 | | | | | | | VIII | Div. 2 Cl. 2 | 19.9 | 0.049 | |
| 8 | | | | | | | EN 13445-3 | | 19.9 | 0.049 | |
| 9 | | 300 | 609. [symbol] | 690 | No | 1 | ASME | Div. 1 | 45.3 | 0.074 | 40 |
| 10 | | | | | | | BPVC Sec. | Div. 2 Cl. 1 | 37.8 | 0.062 | |
| 11 | | | | | | | VIII | Div. 2 Cl. 2 | 29.9 | 0.049 | |
| 12 | | | | | | | EN 13445-3 | | 29.9 | 0.049 | |
| 13 | | 350 | 609. [symbol] | 690 | No | 1 | ASME | Div. 1 | 53.6 | 0.088 | 34 |
| 14 | | | | | | | BPVC Sec. | Div. 2 Cl. 1 | 44.5 | 0.073 | |
| 15 | | | | | | | VIII | Div. 2 Cl. 2 | 35.1 | 0.058 | |
| 16 | | | | | | | EN 13445-3 | | 35.2 | 0.058 | |
| 17 | | 200 | 762 | 460 | No | 0.85 | ASME | Div. 1 | 61.5 | 0.081 | 60 |
| 18 | | | | | | | BPVC Sec. | Div. 2 Cl. 1 | 51.2 | 0.067 | |
| 19 | | | | | | | VIII | Div. 2 Cl. 2 | 40.4 | 0.053 | |
| 20 | | | | | | | EN 13445-3 | | 40.5 | 0.053 | |
| 21 | | 500 | 355.6 | 690 | No | 1 | ASME | Div. 1 | 45.1 | 0.127 | 24 |
| 22 | | | | | | | BPVC Sec. | Div. 2 Cl. 1 | 36.9 | 0.104 | |
| 23 | | | | | | | VIII | Div. 2 Cl. 2 | 29.0 | 0.081 | |
| 24 | | | | | | | EN 13445-3 | | 29.0 | 0.082 | |
| 25 | | 1000 | 203.2 | 690 | No | 1 | ASME | Div. 1 | 60.8 | 0.299 | 12 |
| 26 | | | | | | | BPVC Sec. | Div. 2 Cl. 1 | 46.6 | 0.229 | |
| 27 | | | | | | | VIII | Div. 2 Cl. 2 | 35.8 | 0.176 | |
| 28 | | | | | | | EN 13445-3 | | 36.1 | 0.178 | |
| 29 | | 100 | 254 | 355 | No | 1 | ASME | Div. 1 | 10.1 | 0.040 | 119 |
| 30 | | | | | | | BPVC Sec. | Div. 2 Cl. 1 | 8.6 | 0.034 | |
| 31 | | | | | | | VIII | Div. 2 Cl. 2 | 6.8 | 0.027 | |
| 32 | | | | | | | EN 13445-3 | | 6.8 | 0.027 | |
| 33 | | 100 | 762 | 355 | Yes | 0.85 | ASME | Div. 1 | 36.0 | 0.047 | 119 |
| 34 | | | | | | | BPVC Sec. | Div. 2 Cl. 1 | 30.4 | 0.040 | |
| 35 | | | | | | | VIII | Div. 2 Cl. 2 | 24.1 | 0.032 | |
| 36 | | | | | | | EN 13445-3 | | 24.1 | 0.032 | |

| | Required length | | Required | Required | | Total | Required | |
|---|---|---|---|---|---|---|---|---|
| | | Per | number | number | Number | Weight of | surface | Specific |
| Examp [symbol] | Total | vessel | of | of | of | assembly | area | storage |
| # | m | m | vessels | closures | stacks | tons | m2 | capacity |
| 1 | 1178 | 107 | 11 | 22 | 3 | 138 | 153 | 4.3 |
| 2 | | | | | | 125 | | 4.3 |
| 3 | | | | | | 99 | | 4.4 |
| 4 | | | | | | 99 | | 4.4 |
| 5 | 307 | 102 | 3 | 6 | 3 | 106 | 64 | 6.4 |
| 6 | | | | | | 84 | | 6.5 |
| 7 | | | | | | 67 | | 6.6 |
| 8 | | | | | | 67 | | 6.6 |
| 9 | 136 | 136 | 1 | 2 | 3 | 106 | 42 | 6.4 |
| 10 | | | | | | 84 | | 6.5 |
| 11 | | | | | | 69 | | 6.6 |
| 12 | | | | | | 69 | | 6.6 |
| 13 | 117 | 117 | 1 | 2 | 3 | 111 | 36 | 6.3 |
| 14 | | | | | | 91 | | 6.4 |
| 15 | | | | | | 72 | | 6.5 |
| 16 | | | | | | 72 | | 6.5 |
| 17 | 131 | 131 | 1 | 2 | 3 | 171 | 51 | 3.6 |
| 18 | | | | | | 144 | | 3.7 |
| 19 | | | | | | 108 | | 3.7 |
| 20 | | | | | | 108 | | 3.7 |
| 21 | 240 | 10 | 25 | 50 | 5 | 127 | 34 | 6.1 |
| 22 | | | | | | 99 | | 6.2 |
| 23 | | | | | | 81 | | 6.3 |
| 24 | | | | | | 81 | | 6.3 |
| 25 | 3 [symbol] 8 | 10 | 37 | 74 | 5 | 160 | 28 | 5.3 |
| 26 | | | | | | 113 | | 5.6 |
| 27 | | | | | | 87 | | 5.8 |
| 28 | | | | | | 87 | | 5.8 |
| 29 | 2356 | 2356 | 1 | 2 | 1 | 171 | 899 | 3.4 |
| 30 | | | | | | 146 | | 3.4 |
| 31 | | | | | | 121 | | 3.4 |
| 32 | | | | | | 121 | | 3.4 |
| 33 | 262 | 262 | 1 | 2 | 1 | 198 | 302 | 2.9 |
| 34 | | | | | | 164 | | 2.9 |
| 35 | | | | | | 130 | | 2.9 |
| 36 | | | | | | 130 | | 2.9 |

[symbol]

indicates data missing or illegible when filed

Table 1 shows various examples, namely: 1-36, to which the mathematical model has been applied. In table 1, Column 1 identifies the tested examples, each example relating to a hydrogen pressure vessel assembly comprising one or more hydrogen pressure vessels, column 2 shows the amount of hydrogen that is to be stored in the pressure vessel assemblies which amount is the same for each example, column 3 shows the applied internal pressure, column 4 shows the (largest) internal diameter of the pressure vessels included in the assembly, column 5 shows the yield strength of the vessel steel, column 6 shows whether or not the example comprises a longitudinal weld, column 7 provides a longitudinal weld strength reduction factor (LWSRF), column 8 indicates various standards according to which a hydrogen pressure vessel may be designed, column 9 specifies the standards of column 8, column 10 provides an indication of the minimum required wall thickness of a vessel in each example, column 11 indicates the wall thickness to internal diameter ratio of the vessels in each example, column 12 provides the required interior volume for each assembly, column 13 indicates the total required assembly length for storing the hydrogen, column 14 indicates a required length per pressure vessel, column 15 indicates the required number of pressure vessels, column 16 provides an indication of the required number of closures, column 17 provides an indication of the number of vessels that may be provided on top of each other, column 18 provides an indication of the total weight of each pressure vessel assembly, column 19 provides an indication of the required surface area required for each assembly, and column 20 indicates for each example the specific storage capacity.

In table 1, examples are compared with each other, wherein the amount of hydrogen to be stored is kept constant for each example. In particular, each example is required to store 1000 kg of hydrogen. This amount of hydrogen is merely exemplary in order to compare examples. In certain cases, a pressure vessel in accordance with the present invention is adapted to store a greater amount of hydrogen.

In particular, the examples have been designed, such to comply with four presently relevant standards, namely: ASME BPVC Section VIII, in particular, Division 1, Division 2 class 1, Division 2 class 2, and EN 13445-3. As follows from the table, sets of examples perform similarly regardless of the applied standard (see e.g. examples 1˜4 have a similar performance in terms of specific storage capacity).

Table 1 shows that when a vessel assembly is adapted to store hydrogen at a pressure greater than 200 bar, and a steel is selected having a yield strength of above 355 MPa (52.2 ksi), hydrogen may be stored in a much smaller surface area as compared to a pipeline operating at 100 bar. Also, the total weight of an assembly adapted to maintain hydrogen at 100 bar may be greater than the total weight of an assembly having seamless vessels.

On the other hand, contrary to what one might expect, storing hydrogen at a pressure of about 300 bar may be more efficient than storing hydrogen at 500 to 1000 bar, when the weight of the vessel is taken into account. In particular, storing hydrogen at 300 bar may be more efficient than storing hydrogen at 350 bar, as can be seen when comparing examples 9 to 12 with 13 to 16. In this regard, it should be noted that the latter is true regardless of the internal diameter. In particular, examples 5 to 8, employing an internal diameter of 406, 4 mm, and examples 9 to 12, employing an internal diameter of 609.6 mm, have the same specific storage capacity.

Table 1 shows how the above may be achieved. In particular, specific values for the internal diameter, the yield strength (e.g. of 460 MPa (66.7 ksi) to 690 MPa (100.1 ksi)), a minimum wall thickness, and/or a minimum wall thickness over internal diameter, may be selected. Further, it should be noted that if the segments do not have a longitudinally extending weld, at least one of the above variables may be less conservatively selected.

Further, it is observed that a hydrogen pressure vessel assembly in accordance with the invention may be less complex. In particular, when the segments have a greater longitudinal length, the hydrogen pressure vessel assembly requires relatively few closures.

An advantage of the present invention is, that the hydrogen storage capacity may be improved, whereas the weight of the to be handled parts, and construction complexity, may be reduced. These advantages may be achieved without reinforcing the steel hydrogen pressure vessel.

### DRAWINGS

For a better understanding of the present invention, and to show how the same may be put into effect, reference will now be made, by way of example only, to the accompanying drawings in which:

FIG. 1 shows a perspective view of a hydrogen pressure vessel assembly in accordance with the present invention;

FIG. 2 shows a top view of the hydrogen pressure vessel assembly of FIG. 1;

FIG. 3 shows a perspective cross sectional view of a first embodiment of the hydrogen pressure vessel in accordance with the present invention;

FIG. 4 shows a cross sectional view of the hydrogen pressure vessel of FIG. 3;

FIG. 5 shows a cross sectional view of a second embodiment of a hydrogen pressure vessel in accordance with the present invention;

FIG. 6 shows a cross sectional view of a third embodiment of a hydrogen pressure vessel in accordance with the present invention; and

FIG. 7 schematically shows a method of manufacturing a hydrogen pressure vessel assembly in accordance with the present invention.

### DETAILED DESCRIPTION OF THE INVENTION

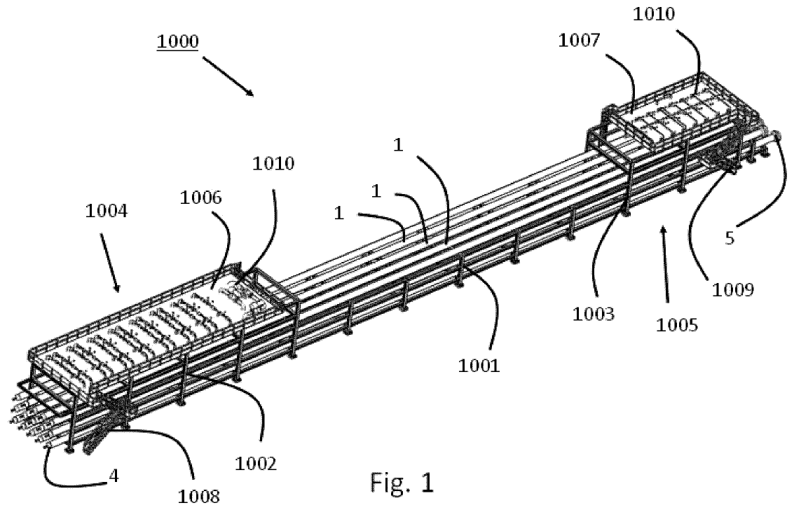

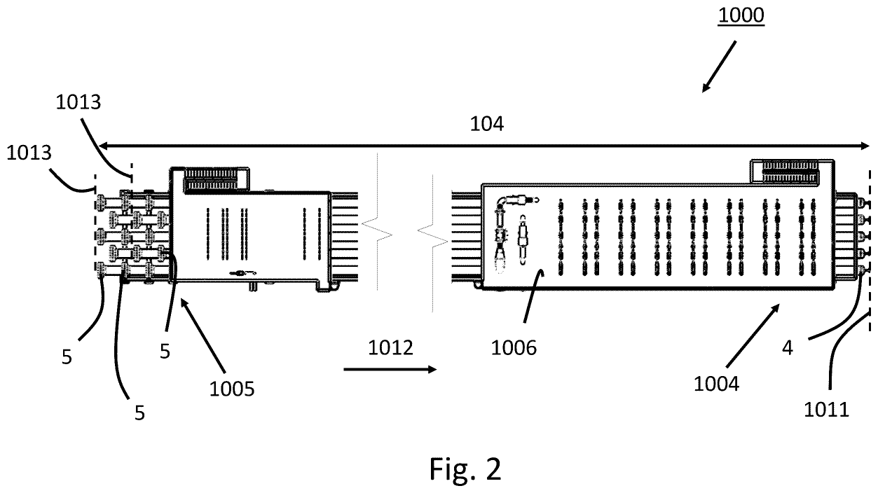

FIGS. 1 and 2 show views of a hydrogen pressure vessel assembly 1000 in accordance with the present invention. The hydrogen pressure vessel assembly 1000 comprises a frame 1001, comprising a first frame part 1002 at a first longitudinal assembly end 1004, and a second frame part 1003 at a second longitudinal assembly end 1005. A plurality of hydrogen pressure vessels 1 is provided in the frame 1001.

The first and second frame parts 1002, 1003 are located at a distance from each other. The first frame part 1002 comprises a first deck 1006 with vessel interaction means 1010. The second frame part 1003 comprises a second deck 1007, which second deck is also provided with vessel interaction means 1010. The first deck 1006 and the second deck 1007 are provided at an elevated position above the vessels 1. The first vessel interaction means 1010 are configured to interact with the valve 6 of each hydrogen pressure vessel. To this end, the vessel interaction means 1010 may comprise a compressor 10. A first and second stairs 1008, 1009 is provided to provide access to the first and second deck 1006, 1007, respectively.

The frame 1001 supports a plurality of vessels 1. In particular, the frame supports 15 hydrogen pressure vessels 1, wherein the vessels 1 are arranged in three rows and five columns.

As can be seen in FIG. 2, the vessels 1 differ in longitudinal length 104, wherein in the assembly 1000, the vessels 1 are arranged such that at the first longitudinal assembly end 1004 the vessels 1 end flush in a first plane 1011 that is perpendicular to a longitudinal direction 1012 of the hydrogen pressure vessel assembly 1000. At the opposite second longitudinal assembly end 1005, the second closures 5 end in multiple second planes 1013 that are perpendicular to the longitudinal direction 1012. In particular, vessels 1 arranged in a row at a lower height (from the ground) may extend up to a second plane 1013 positioned at shorter distance from the first plane 1011 than vessels 1 in a row at a greater height. This promotes easy inspection at the second axial pressure vessel end 102.

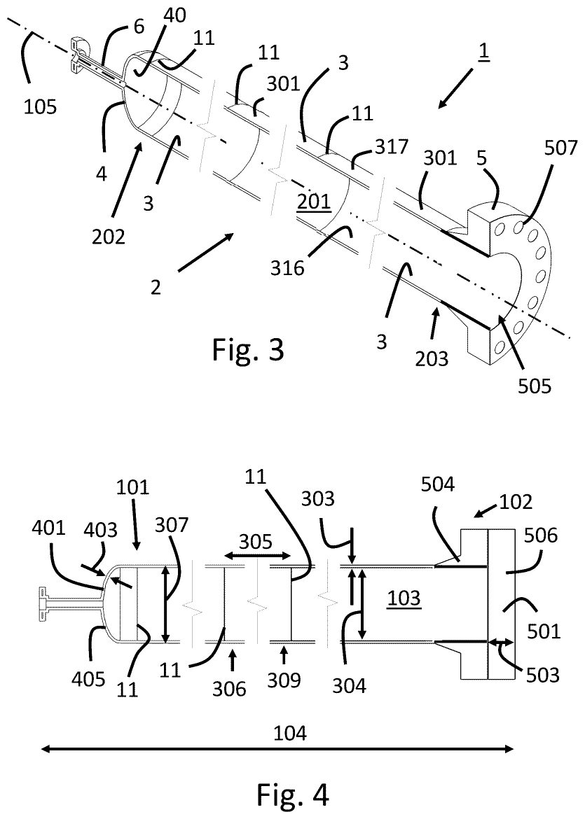

FIGS. 3 and 4 show detailed views a hydrogen pressure vessel 1 in accordance with the present invention. In particular, the hydrogen pressure vessel 1 of FIGS. 3 and 4 is one of the vessels 1 as shown in FIGS. 1 to 2.

The hydrogen pressure vessel 1, comprises a shell 2, a first closure 4 at a first axial pressure vessel end 101, and a second closure 5 at a second axial pressure vessel end 102. The shell 2, first closure 4, and second closure 5 together define an interior volume 103 of the hydrogen pressure vessel 1. The hydrogen pressure vessel is adapted to hold hydrogen in the interior volume 103 at a pressure of 300 bar (4351 psi).

The pressure vessel 1 has a longitudinal axis 105, wherein the vessel 1 extends in a single longitudinal direction. The longitudinal axis 105 of the vessel 1 and the longitudinal axis of the shell 2 are the same.

The hydrogen pressure vessel 1 has a longitudinal vessel length 104, which is defined by the first closure 4, the second closure 5, and the shell 2. The longitudinal vessel length is, in particular, 100 to 140 meters.

The shell 2 is formed by a multitude of longitudinally extending segments 3. In FIGS. 3 and 4, the segments have a cylindrical circumferential wall 301. The longitudinal axis of each of the segments 3 is concentric. In particular, longitudinally extending segments 3 are aligned around the same longitudinal axis 105. The longitudinal length of the segments 3 is 30 to 100 meters.

The shell 2 is connected by means of a weld 11 at a first axial shell end 202 to the first closure 4, and at a second axial shell end 203 to the second closure 5.

The circumferential walls 301 of the segments 3 together define a single internal volume 201 of the shell 2. In particular, the segments 3 are arranged such that hydrogen can flow from one segment to another. The circumferential wall 301 has an internal circumferential wall surface 316, and an external circumferential wall surface 317. The internal circumferential wall surface 316 may be in contact with hydrogen kept at the internal volume 201. The internal circumferential wall surface 316 may be provided with a hydrogen inhibiting coating (not shown).

The segments 3 are connected to each other by means of welds 11 that extend along the circumferential walls 301 of the segments 3. The segments 3 are seamless. The segments 3 are, and thus also the shell 2 is, free from a weld extending substantially parallel to the longitudinal axis 105.

Further, the segments 3 are free from an internal support structure that would strengthen the circumferential walls 301. Even further, there is no external support structure, such a one or more rings mounted at the external surface of the circumferential wall 301, that strengthens the circumferential walls 301 to aid with maintaining the pressurized hydrogen. In this regard, it is noted that the frame 1001 supports the vessels 1 by maintaining the vessels 1 at a distance from the ground, but the frame 1001 is not adapted to provide support in maintaining the pressurized hydrogen.

The circumferential wall 301 of each of the segments is formed from a steel having a yield strength greater than 355 MPa (megapascal). In particular, the yield strength of the steel is 690 MPa.

The circumferential wall 301 of each segment has the same wall thickness 303, each wall having the same internal diameter 304. The wall thickness 303 is 19.9 millimeters to 45.3 millimeters. The internal diameter 304 is 406.4 millimeters to 609.6 millimeters. As such, the wall thickness over internal diameter ratio is 0.049 to 0.074.

Each segment 3 has a first axial segment end 306, and a second axial segment end 309 defining a longitudinal segment length 305. At the first axial segment end 306, the segment 3 has a first external diameter 307, and a first internal diameter 308. At the second axial segment end 309, the segment 3 has a second external diameter 310, and a second internal diameter 311. The external diameters 307, 310 are the same. The internal diameters are also 308, 311 are also the same.

The first closure 4 has a first closure wall 401, and a valve 6. The first closure wall 401 is connected to the circumferential wall 301 of a segment 3 by means of a weld 11. The first closure wall 401 has a first closure wall thickness 403 that is equal to the wall thickness 303 of the circumferential wall 301. Further, the first closure wall 401 has a first closure wall internal surface 404, and a first closure wall external surface 405. The first closure wall 401 is dome shaped, wherein the diameter of the wall decreases from the weld 11 towards the valve 6 of the first closure 401, which valve 6 has a longitudinal portion 61, the longitudinal axis of which is aligned with the longitudinal axis of the vessel 105.

The second closure 5 is also connected to a segment 3 by means of a weld 11. The first and second closures 4, 5 may both be dome shaped, wherein one or both closures 4, 5 comprise a valve 6. That said, the second closure 5 is different from the first closure 4. In particular, the second closure 5 comprises a flange 5. The flange 5 has two parts, namely a first flange part 504, connected to a segment 3, which first flange part 504 has an opening 505, and a second flange part 506, which closes the first flange part opening 505. The first part of the flange 504 is connected to the second part of the flange 506 by means of bolts provided in bores 507 along the circumference of the flange 5. Such flange allows servicing and monitoring at the inside of the hydrogen pressure vessel. Due to this configuration, the second closure wall 501 is defined partly by the first flange part 504, and partly by the second flange part 506. The part 506 has a second closure wall thickness 503 that is greater than the circumferential wall thickness 303.

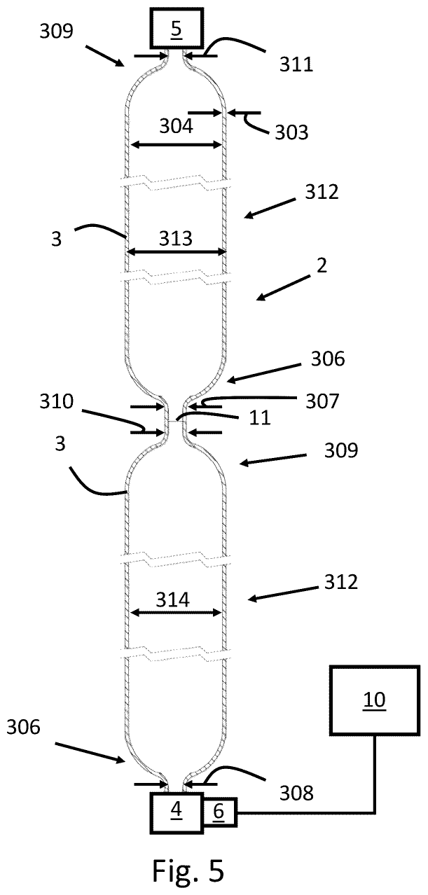

FIG. 5 shows a cross sectional view of a second embodiment of a hydrogen pressure vessel 1 in accordance with the present invention. Again, the hydrogen pressure vessel 1 comprises a shell 2, a first closure 4, and a second closure 5. In addition, FIG. 5 shows a compressor 10 that is in fluid communication with a valve 6 located at the first closure 4. The shell 2 is depicted as having two longitudinally extending segments 301. However, it is to be understood that in practice the shell 2 is formed by more than two segments 3.

Different from the embodiment shown in FIGS. 3 and 4, the segments of the embodiment shown in FIG. 5 have a first axial segment end 306 with a first external diameter 307 and a first internal diameter 308, a second axial segment end 309 with a second external diameter 310 and a second internal diameter 311, and a main segment body 312 with a third external diameter 313 and a third internal diameter 314. The main segment body 313 is connected to the first axial segment end 306 as well as to the second axial segment end 309.

The first external diameter 307, the first internal diameter 308, the second external diameter 310, and the second internal diameter 311, are smaller than the third external diameter 313 and the third internal diameter 314. In such case, one should take into account the wall thickness 303 over largest internal diameter 314 when designing the hydrogen pressure vessel 1.

In particular, the first and second axial segment ends 306, 309 are dome shaped, wherein the first and second external and internal diameters 307, 308, 310, 311 increase towards the main segment body 313. The wall thickness of the circumferential wall 301 is the same at the first axial segment end 306, the second axial segment end 309, and the main segment body 312.

It should be noted that the first and second segment ends 306, 309 are not welded to the main segment body 312. The segments 3 are, on the other hand, welded to each other by means of a weld 11, which weld 11 extends in a plane perpendicular to the longitudinal axis 105.

As is clear from FIG. 5, this welds 11 are provided at a diameter that is smaller than the diameter of the main segment body 312.

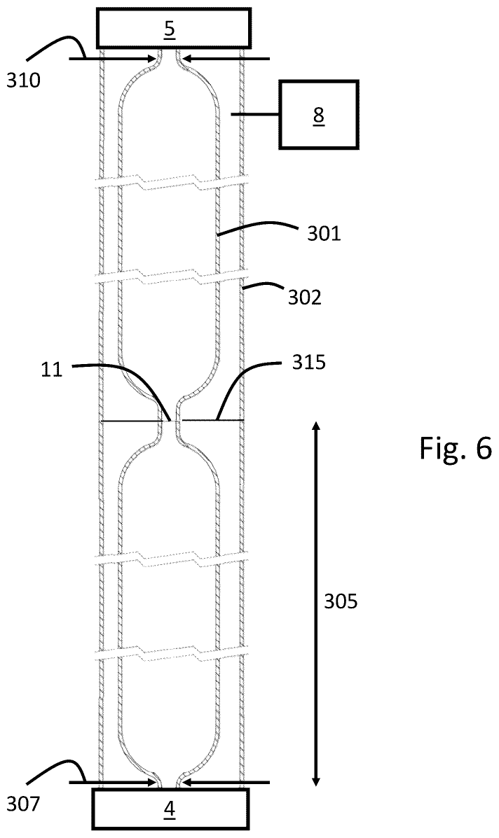

FIG. 6 shows a cross sectional view of a third embodiment of a hydrogen pressure vessel 1 in accordance with the present invention. The third embodiment is similar to the embodiment shown in FIG. 5. That said, in the embodiment of FIG. 6, the circumferential wall 301 of each segment 3 is an internal circumferential wall 301, and each segment 1 further comprises an external circumferential wall 302 located at a distance from the internal circumferential wall 301. In particular, the external circumferential wall 302 is located at a greater diameter than the internal circumferential wall 301. In practice, the external circumferential wall 302 is also connected to the internal circumferential wall 302 my means of two or more spacers 315. The external circumferential wall 302 is connected to the first closure 4 and to the second closure 5. The pressure vessel 1 further comprises hydrogen detection means 8 for detecting hydrogen (gas) between the internal 301 and external 302 circumferential wall.

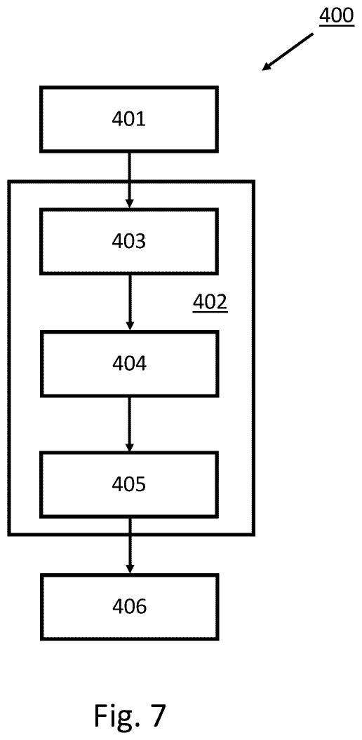

FIG. 7 schematically shows a method 400 of manufacturing a hydrogen pressure vessel assembly 1000 in accordance with the present invention. The method 400 comprises the steps of:
arranging 401, at a storage location, a frame 1001, the frame 1001 being adapted to hold a plurality of hydrogen pressure vessels 1;
manufacturing 402 a hydrogen pressure vessel 1, comprising the steps of:
   providing 404 a multitude of longitudinally extending segments 3, a first closure 4, and a second closure 5;
   connecting 405 the multitude of longitudinally extending segments 3, the first closure 4, and the second closure 5; and
attaching 406 a compressor 10 to the hydrogen pressure vessel 1.

In particular, the step of manufacturing 402 comprises the step of positioning 403, more in particular, with a conventional hoisting means (such as a crane):
the multitude of longitudinally extending segments 3, wherein the longitudinal axis 105 of the segments is concentric, and wherein the segments are adjacent to each other; and
the first closure 4 adjacent to the first axial segment end 306 of one of the segments 3, and the second closure 5 adjacent to the second axial segment end 309 of another one of the segments 3.

The step of connecting 405 preferably comprises the steps of welding the segments 3 together to form the shell 2 with the internal volume 105, welding the first closure 4 to the first axial segment end 306, and welding the second closure 5 to the second axial segment end 309, to form the hydrogen pressure vessel 1.

The step of arranging 401 the frame 1001 may be performed before performing the method 402, in particular before the step of providing 404 the vessel parts 3, 4, 5. Preferably, the step of positioning 403 entails placing the connectable parts 3, 4, 5 in the frame 1001. The method 402 is repeated to fill the frame 1001.

As required, detailed embodiments of the present invention are disclosed in the figures; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The terms “a” or “an”, as used herein, are defined as one or more than one. The terms multitude, multiple and plurality, as used herein, are defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the shown hydrogen pressure vessel, hydrogen pressure vessel assembly, and method according to the invention without departing from the scope as defined in the claims.

1. A hydrogen pressure vessel, comprising a shell with an internal volume; wherein:
the pressure vessel is arranged for storing compressed hydrogen at a pressure greater than 200 bar;
the shell is made of a steel having a yield strength (S_{y}) of at least 355 MPa; and
said shell is formed by a multitude of longitudinally extending segments, wherein each longitudinally extending segment has a circumferential wall, with a wall thickness (WT), defining an internal diameter (ID₁), the multitude of longitudinally extending segments together forming the internal volume of the shell.

2. (canceled)

3. The hydrogen pressure vessel of claim 1, wherein the longitudinally extending segments comply with:
$$0.045 \leq \frac{{WT}_{min}}{{ID}_{1}} \leq 0.299 ,$$
wherein WTₘᵢₙ is the minimum required wall thickness of the segments, and ID₁ is the internal diameter of the segments.

4. The hydrogen pressure vessel of claim 1, wherein the longitudinally extending segments comply with:
$$0.045 \leq \frac{{WT}_{min}}{{ID}_{1}} \leq 0.088$$

5. The hydrogen pressure vessel of claim 1, wherein the steel of the shell, complies with:
$$460 MPa \leq {S}_{y} \leq 690 MPa$$
wherein S_{y} is the yield strength of the steel.

6. The hydrogen pressure vessel of claim 1, wherein the longitudinally extending segments comply with:
$$203 mm \leq {ID}_{1} \leq 610 mm$$

7. The hydrogen pressure vessel of claim 1, wherein the longitudinally extending segments comply with:
$$11.4 mm \leq {WT}_{min} \leq 60.8 mm$$

8. The hydrogen pressure vessel of claim 1, wherein the pressure vessel is arranged for storing compressed hydrogen at a pressure of 200 bar to 1000 bar.

9. (canceled)

10. (canceled)

11. The hydrogen pressure vessel of claim 1, wherein the vessel has a longitudinal vessel length of at least 100 meters.

12. (canceled)

13. The hydrogen pressure vessel of claim 1, wherein the longitudinally extending segments have a longitudinal segment length of 30 meter to 100 meters.

14. The hydrogen pressure vessel of claim 1, wherein each segment is seamless.

15. (canceled)

16. The hydrogen pressure vessel of claim 1, wherein the segments comprise a first axial segment end having a first external diameter, a second axial segment end having a second external diameter, and a main segment body, located between the first axial segment end and the second axial segment end, said main segment body having a third external diameter and wherein the shell comprises segments of which the third external diameter is greater than the first external diameter and the second external diameter.

17. (canceled)

18. (canceled)

19. The hydrogen pressure vessel of claim 1, wherein the circumferential wall of each segment is an internal circumferential wall, and each segment further comprises an external circumferential wall located at a distance from the internal circumferential wall.

20. The hydrogen pressure vessel of claim 19, further comprising hydrogen detection means for detecting hydrogen between the internal and external circumferential wall.

21. (canceled)

22. The hydrogen pressure vessel of claim 1, further comprising a first closure at a first axial shell end, and a second closure at a second axial shell end opposite the first axial shell end, wherein the shell, the first closure, and the second closure are made of a ferritic stainless steel.

23. A hydrogen pressure vessel assembly, comprising a plurality of hydrogen pressure vessels of claim 1.

24. (canceled)

25. A method of manufacturing a hydrogen pressure vessel, comprising:
providing a multitude of longitudinally extending segments, a first closure, and a second closure, the segments being made of a steel having a yield strength (S_{y}) of at least 355 MPa; wherein each longitudinally extending segment has a circumferential wall, with a wall thickness (WT), defining an internal diameter (ID₁); and
connecting the multitude of longitudinally extending segments, the first closure, and the second closure to form a hydrogen pressure vessel with a shell having an internal volume.

26. The hydrogen pressure vessel of claim 4, wherein the longitudinally extending segments comply with:
$$0.045 \leq \frac{{WT}_{min}}{{ID}_{1}} \leq 0.088 .$$

27. The hydrogen pressure vessel of claim 8, wherein the pressure vessel is arranged for storing compressed hydrogen at a pressure of 200 bar to 500 bar.

28. The hydrogen pressure vessel of claim 27, wherein the pressure vessel is arranged for storing compressed hydrogen at a pressure of 200 bar to 350 bar.

29. The hydrogen pressure vessel of claim 28, wherein the pressure vessel is arranged for storing compressed hydrogen at a pressure of 300 bar.
